(19) United States
(12) Patent Application Publication
(10) Pub. No.: US 2009/0089795 A1
(43) Pub. Date: Apr. 2, 2009

(54) Information processing apparatus, control method of information processing apparatus, and control program of information processing apparatus

(75) Inventors: Hideki Yoshida, Tokyo (JP); Nobuo Sakiyama, Kawasaki-shi (JP); Tetsuro Kimura, Tokyo (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/230,452

(22) Filed: Aug. 28, 2008

(30) Foreign Application Priority Data
Sep. 27, 2007 (JP) 2007-252025

(51) Int. Cl. G06F 9/46

(52) U.S. Cl. 718/107

(57) ABSTRACT

According to an embodiment of the invention, a computer readable storage medium that stores a software program causing a computer system to perform a scheduling process for executing a plurality of application programs in every processor cycles, the scheduling process includes: allocating, during a current processor cycle, processor times of a next processor cycle to each of the application programs to be executed in the next processor cycle; storing the allocated processor times of the next processor cycle; determining whether or not the application programs executed in the current processor cycle include an uncompletable application program; calculating processor idle time of the next processor cycle; and allocating an additional processor time of the next processor cycle to the uncompletable application program, the additional processor time being set not to exceed the calculated processor idle time of the next processor cycle.

### CROSS-REFERENCE TO RELATED APPLICATIONS

This application is based upon and claims the benefit of priority from Japanese Patent Application No. 2007-252025, filed Sep. 27, 2007, the entire contents of which are incorporated herein by reference.

### BACKGROUND OF THE INVENTION

1. Field

The present invention relates to an information processing apparatus, a control method of the information processing apparatus, and a control program of the information processing apparatus.

2. Related Art

A sensor information system for displaying the surrounding circumstances or the environment kept track of by a sensor on a screen in real time is used for a transport such as a ship, an airplane, or an automobile. For example, a ship includes a plurality of sensors of a radar, a sonar, an infrared sensor, a camera, etc., and keeps track of the surrounding circumstances or the environment by analyzing the sensing results of the sensors in response to each phase. By keeping track of the surrounding circumstances or the environment, the ship circumvents a collision and realizes safe navigation.

To immediately inform the user of the surrounding circumstances or the environment kept track of by the sensors, the sensor information system included in each transport must update the surrounding circumstances or the environment displayed on the screen every period of a predetermined time or less.

Thus, in the sensor information system, an application for analyzing the sensing results from the various sensors and an application for displaying the analysis result on the screen are executed every given period. Such an application has a feature that when execution processing is started in one period, it needs to be completed within the period, but the execution processing may be executed at any timing within the period.

To allocate the CPU (Central Processing Unit) time to the application having such a feature (which will be hereinafter called CPU time scheduling), the total of the CPU times allocated to applications in one period becomes important.

For example, a QoS (Quality of Service) application resource allocation technique based on a market mechanism is available as a system of scheduling such applications for sensor signal analysis considering the period. (For example, refer to non-patent document 1.)

In the technique disclosed in “Shijyou mechanism nimotozuku Qos tekiou resource wariategijyutsu,” Toshiba Review, Vol. 62, No. 3, 2007, (March in 2007), Internet http://www.toshiba.co.jp/tech/review/2007/03/62_{—}03pdf/01_{—}1.pdf, each application bits for the CPU time using virtual currency and acquires the CPU time for each predetermined unit.

In the technique disclosed in non-patent document 1, it is necessary to estimate correctly the time required for application execution processing beforehand. However, the actual time required for the application execution processing varies depending on the causes of a communication delay with various sensors, a cache miss, etc.

Thus, even if the time required for application execution processing is estimated beforehand and the CPU time is allocated so that the application execution processing is complete within the period, a situation in which the application execution processing is not complete within the period occurs.

If the application execution processing is not complete within the period, it is aborted. As the application execution processing is aborted, a defective condition such that analysis of the sensing result is not sufficiently conducted or that information indicating the surrounding circumstances or the environment is not correctly displayed on a screen occurs and it is feared that safe navigation of a ship may be hindered, for example.

### SUMMARY OF THE INVENTION

According to one embodiment of the present invention, there is provided a computer readable storage medium that stores a software program causing a computer system to perform a scheduling process for executing a plurality of application programs in every processor cycles, the scheduling process including: allocating, during a current processor cycle, processor times of a next processor cycle to each of the application programs to be executed in the next processor cycle; storing the allocated processor times of the next processor cycle; determining whether or not the application programs executed in the current processor cycle include an uncompletable application program that will not be completed within the current processor cycle; calculating processor idle time of the next processor cycle from a difference between a sum of the stored processor times of the next processor cycle and a length of the processor cycle, when determined that the uncompletable application program is included in the application programs executed in the current processor cycle; and allocating an additional processor time of the next processor cycle to the uncompletable application program, the additional processor time being set not to exceed the calculated processor idle time of the next processor cycle.

According to another embodiment of the present invention, there is provided a control method of an information processing apparatus to perform a scheduling process for executing tasks for a plurality of application programs in every processor cycles, the control method including: allocating, during a current processor cycle, processor times of a next processor cycle to each of the application programs to be executed in the next processor cycle; storing the allocated processor times of the next processor cycle; determining whether or not the application programs executed in the current processor cycle include an uncompletable application program that will not be completed within the current processor cycle; calculating processor idle time of the next processor cycle from a difference between a sum of the stored processor times of the next processor cycle and a length of the processor cycle, when determined that the uncompletable application program is included in the application programs executed in the current processor cycle; and allocating an additional processor time of the next processor cycle to the uncompletable application program, the additional processor time being set not to exceed the calculated processor idle time of the next processor cycle.

According to another embodiment of the present invention, there is provided an information processing apparatus including: a processor that executes a plurality of application programs in every processor cycles; and a memory that stores processor times, wherein the processor operates: allocating, during a current processor cycle, processor times of a next processor cycle to each of the application programs to be executed in the next processor cycle; storing the allocated processor times of the next processor cycle to the memory; determining whether or not the application programs executed in the current processor cycle include an uncompletable application program that will not be completed within the current processor cycle; calculating processor idle time of the next processor cycle from a difference between a sum of the stored processor times of the next processor cycle and a length of the processor cycle, when determined that the uncompletable application program is included in the application programs executed in the current processor cycle; and allocating an additional processor time of the next processor cycle to the uncompletable application program, the additional processor time being set not to exceed the calculated processor idle time of the next processor cycle.

According to another embodiment of the present invention, there is provided an information processing apparatus including: a processor that executes a plurality of application programs in every processor cycles; a first allocation unit that allocates processor times of next processor cycle to each task of next application programs to be executed in the next processor cycle during the current processor cycle; a storing unit that stores the allocated processor times of the next processor cycle; a determination unit that determines whether or not the application programs executed in the current processor cycle include an uncompletable application program that will not be complete within the current processor cycle; a calculation unit that calculates processor idle time of the next processor cycle from a difference between a sum of the stored processor times of the next processor cycle and a length of the processor cycle, when determined that the uncompletable application program is included in the application programs executed in the current processor cycle; and a second allocation unit that allocates an additional processor time of the next processor cycle to the uncompletable application program, the additional processor time being set not to exceed the calculated processor idle time of the next processor cycle.

### BRIEF DESCRIPTION OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram to show the configuration of a sensor information system according to a first embodiment;

FIG. 2 is an exemplary block diagram to show the configuration of software executed by CPUs;

FIG. 3 is an exemplary block diagram to show the configuration of a radar screen display application and a scheduler;

FIG. 4 is an exemplary flowchart to show the operation of an information processing apparatus according to the first embodiment;

FIG. 5 is an exemplary drawing to show the CPU time allocated to each application in the current period;

FIG. 6 is an exemplary drawing to show the CPU time allocated to each application in the next period;

FIG. 7 is an exemplary drawing to show timings at which the scheduler 2 and the applications are executed;

FIG. 8 is an exemplary drawing to show the CPU time required for execution processing of each application;

FIG. 9 is an exemplary drawing to show the number of pixels of a display section of a display;

FIG. 10 is an exemplary block diagram to show an example of the configuration of codes of the radar screen display application 3b;

FIG. 11 is an exemplary block diagram to show an example of the configuration of codes of the radar signal analysis application;

FIG. 12 is an exemplary flowchart to show the operation of the information processing apparatus according to the first embodiment;

FIG. 13 is an exemplary flowchart to show the operation of the information processing apparatus according to the first embodiment;

FIG. 14 is an exemplary flowchart to show the operation of the information processing apparatus according to the first embodiment; and

FIG. 15 is an exemplary block diagram to show an example of the configuration of codes of a radar screen display application.

### DETAILED DESCRIPTION OF THE INVENTION

Referring now to the accompanying drawings, there are shown preferred embodiments of the invention.

### FIRST EMBODIMENT

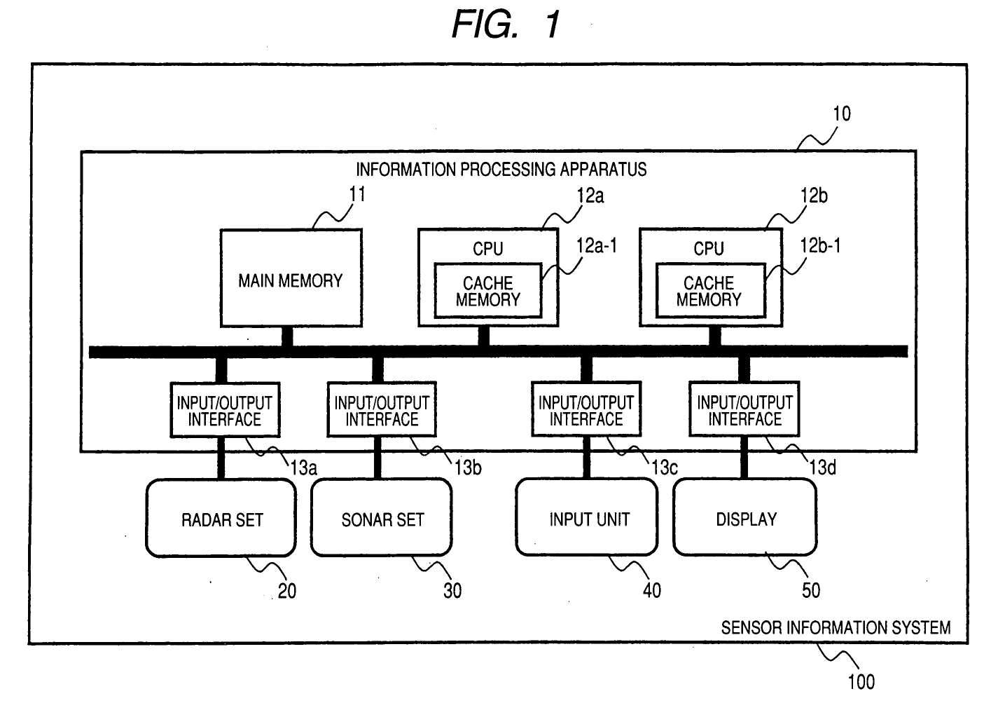

FIG. 1 is a block diagram to show the configuration of a sensor information system 100 according to a first embodiment of the invention.

The sensor information system 100 according to the first embodiment of the invention includes an information processing apparatus 10, a radar set 20, a sonar set 30, an input unit 40, and a display 50. The information processing apparatus 10 includes a CPU 12A, a CPU 12B, main memory 11, and input/output interfaces 12A to 13D. The CPU 12A contains cache memory 12A-1 and the CPU 12B contains cache memory 12B-1.

The CPU 12A, the CPU 12B, the main memory 11, and the input/output interfaces 12A to 13D are connected by a bus line. The input/output interface 12A is connected to the input unit 40. The input/output interface 12-B is connected to the display 50. The input/output interface 13C is connected to the radar set 20. The input/output interface 13D is connected to the sonar set 30.

The sensor information system 100 is installed in a transport such as a ship, an airplane, etc. It is a real-time system for informing a crewman (user) of a dangerous obstacle, etc., for example, without delay by measuring the surrounding circumstances or the environment by the radar set 20 and the sonar set 30 and displaying the measurement result on the display 50 as screen information. The sensor information system 100 measures the surrounding circumstances or the environment by the radar set 20 and the sonar set 30 every 1000 msec and displays the measurement result as screen information in succession.

The radar set 20 emits a radio wave and measures the reflected wave of the radio wave from an obstacle or a target. It stores information concerning the reflected wave of the radio wave of the measurement result (which will be hereinafter called the sensing result) in the main memory 11 through the input/output interface 12A. The sensing result of the radar set 20 is analysed, whereby the distance, the azimuth, etc., of an obstacle or a target existing in the surroundings are obtained.

The sonar set 30 emits an acoustic wave and measures the reflected wave of the acoustic wave from an obstacle or a target. It stores information concerning the reflected wave of the acoustic wave of the measurement result (which will be hereinafter called the sensing result) in the main memory 11 through the input/output interface 12B. The sensing result of the sonar set 30 is analyzed, whereby the distance, the azimuth etc., of an obstacle or a target existing in the surroundings are obtained.

The input unit 40 is a unit of a keyboard, a mouse, etc., for the user to enter information. The user specifies how the sensing results of the sonar set 30 and the radar set 20 are to be displayed on the display 50 by operating the input unit 40. The user-entered information is transmitted to the CPUs 12A and 12B through the input/output interface 13C.

The information processing apparatus 10 analyzes the sensing results of the radar set 20 and the sonar set 30. It creates screen information from the analysis result in accordance with the information input from the input unit 40 and transmits the screen information to the display 50 through the input/output interface 13D.

The display 50 is a display for displaying the screen information transmitted from the information processing apparatus 10.

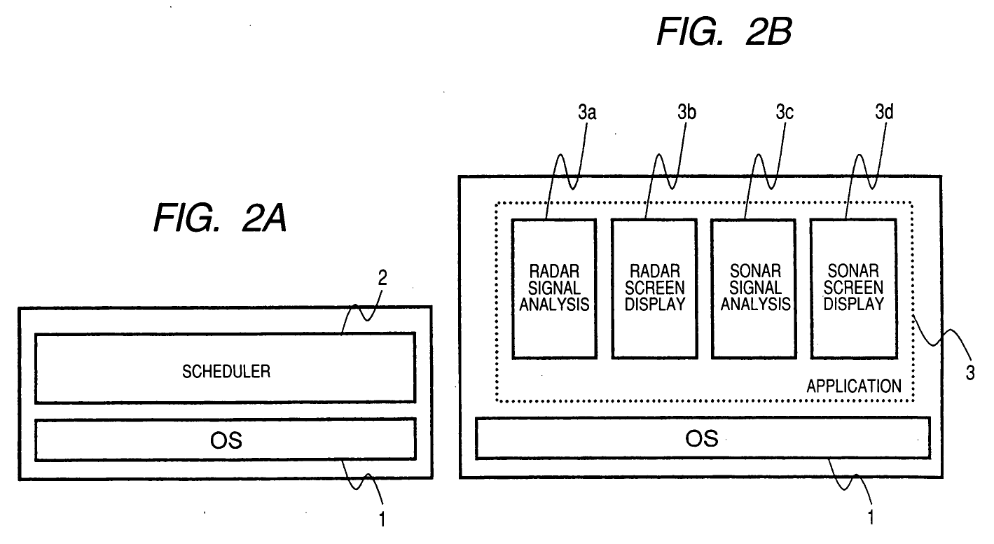

FIG. 2 (a) is a block diagram to show the configuration of software executed by the CPU 12A and FIG. 2 (b) is a block diagram to show the configuration of software executed by the CPU 12B.

The CPUs 12 and 12B execute the same OS (Operating System) 1 corresponding to a multiprocessor, for example, Windows® or Linux®. The CPU 12A executes not only the OS 1, but also a scheduler 2 as middleware. The CPU 12B executes not only the OS 1, but also a radar signal analysis application 3a, a radar screen display application 3b, a sonar signal analysis application 3c, and a sonar screen display application 3d.

The CPUs 12A and 12B access the main memory 11, control the input/output interfaces 12A to 13D, process the input information from the input unit 40, display screen information on the display 50, etc., in accordance with the OS 1. The CPUs 12A and 12B allocate the CPU time for each time slice (50 msec) in a round robin manner to a plurality of programs in an executable state (for example, the scheduler 2 and the applications 3) in accordance with the OS 1. The CPU time allocated to each program is the time during which the CPU 12A or 12B performs execution processing of the program.

The CPU 12A determines the CPU time allocated for each period to each application 3 in accordance with the scheduler 2. The CPU 12A allocates the CPU time for each application in response to the priority of the application 3.

The CPU 12B reads the sensing result from the radar set 20 from the main memory 11, analyzes the sensing result, and forms information indicating the distance, the azimuth, etc., of an obstacle or a target existing in the surroundings in accordance with the radar signal analysis application 3a.

The CPU 12B converts the analysis result provided by executing the radar signal analysis application 3a into screen information to be displayed on the display 50 in accordance with the radar screen display application 3b.

The CPU 12B reads the sensing result from the sonar set 30 from the main memory 11, analyzes the sensing result, and forms information indicating the distance, the azimuth, etc., of an obstacle or a target existing in the surroundings in accordance with the sonar signal analysis application 3c.

The CPU 12B converts the analysis result provided by executing the sonar signal analysis application 3c into screen information to be displayed on the display 50 in accordance with the sonar screen display application 3d.

Since the sensor information system 100 measures the surrounding circumstances or the environment by the radar set 20 and the sonar set 30 every 1000 msec and displays the measurement result as screen information in succession, the CPUs 12A and 12B need to complete the execution processing of the radar signal analysis application 3a, the radar screen display application 3b, the sonar signal analysis application 3c, and the sonar screen display application 3d within the period (1000 msec).

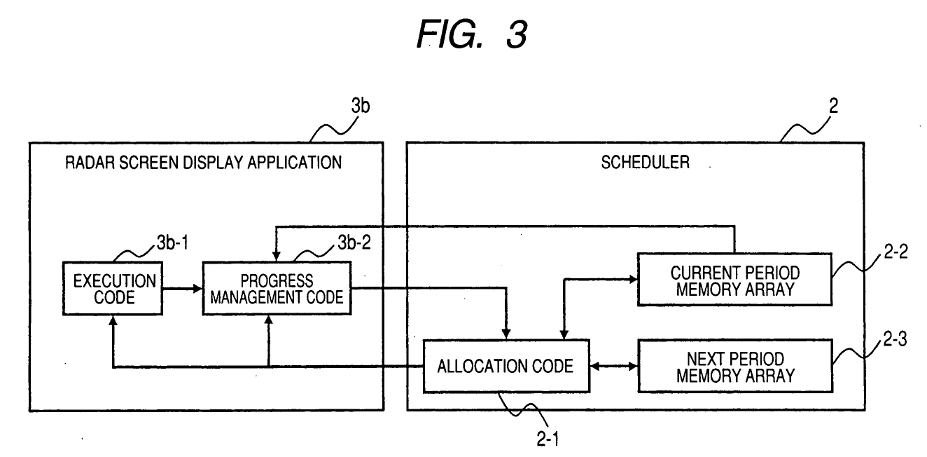

FIG. 3 shows the relationship between the scheduler 2 executed by the CPU 12A and the radar screen display application 3b executed by the CPU 12B. Similar comments also apply to the relationship between the scheduler 2 executed by the CPU 12A and the radar signal analysis application 3a, the sonar signal analysis application 3c, and the sonar screen display application 3d executed by the CPU 12B.

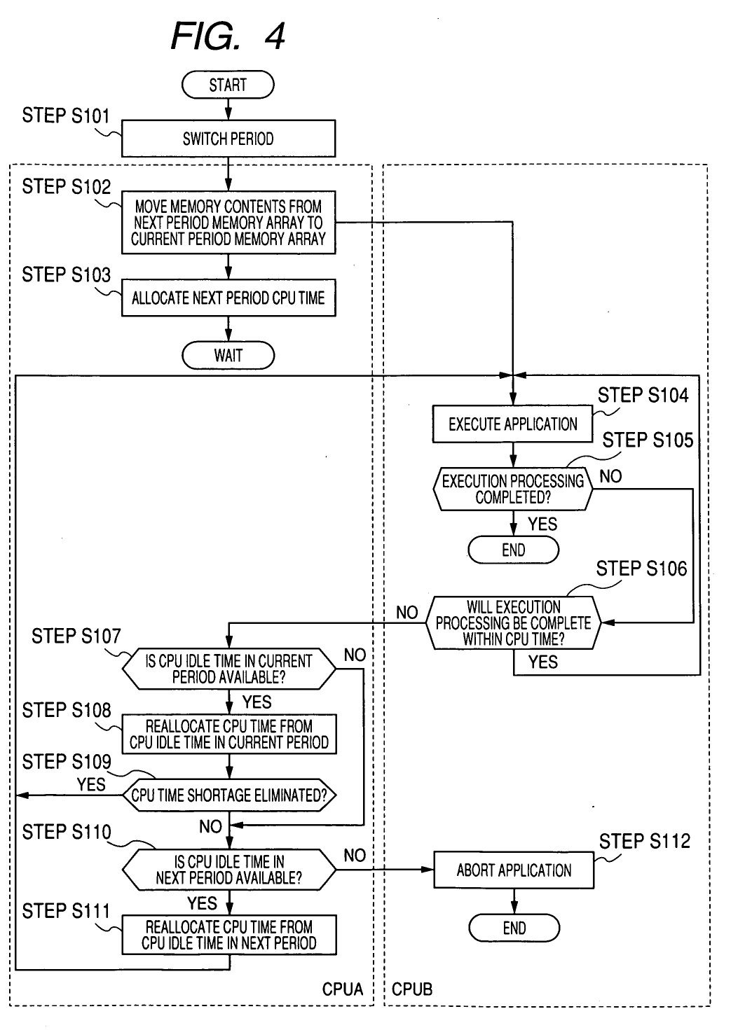

FIG. 4 is a flowchart to show the operation of the CPUs 12A and 12B in one period when the scheduler 2 and the radar screen, display application 3b are executed. The CPUs 12A and 12B of the sensor information system 100 repeat similar processing every period.

To begin with, the preceding period (1000 msec) terminates and switches to the current period (1000 msec) (step S101). It is assumed that in the preceding period; the allocation result of the CPU time to each application 3 in the current period is stored in the main memory 11 as a next period storage array 2-3.

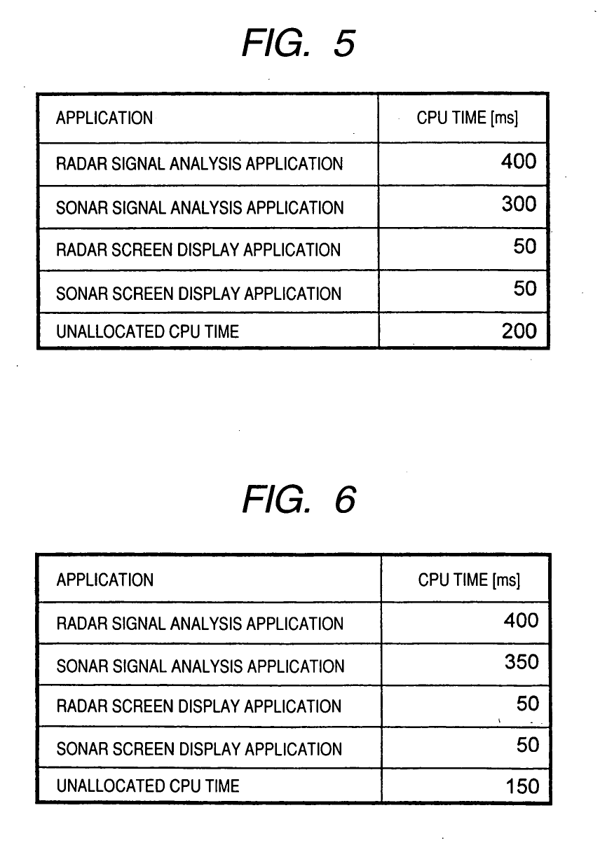

FIG. 5 shows the allocation result of the CPU time to each application 3 in the current period. Since the length of the period is 1000 msec and the total of the CPU times allocated to the applications 3 is 800 msec, the CPU idle time (unallocated CPU time) in the current period is 200 msec.

Next, the CPU 12A again stores the allocation result of the CPU time to each application 3 in the current period stored in the main memory 11 as the next period storage array 2-3 in the main memory 11 as a current period storage array 2-2 in accordance with an allocation code 2-1 of the scheduler 2 (step S102).

Next, the CPU 12A allocates the CPU time to each application 3 in the next period and stores the allocation result in the main memory 11 as the next period storage array 2-3 in accordance with the allocation code 2-1 (step S103). Then, the CPU 12A enters a wait state.

FIG. 6 shows the allocation result of the CPU time to each application 3 in the next period. Since the length of the period is 1000 msec and the total of the CPU times allocated to the applications 3 is 850 msec, the CPU idle time (unallocated CPU time) in the next period is 150 msec.

Next, the CPU 12B starts execution of the radar screen display application 3b because the CPU time is allocated to the radar screen display application 3b. The CPU 12B executes the radar signal analysis application 3a, the sonar signal analysis application 3c, and the sonar screen display application 3d in a similar manner, the description of which is skipped.

Next, the CPU 12B analyzes the sensing result of the radar set 20 in accordance with an execution code 3b-1 of the radar screen display application 3b (step S104).

If the execution processing of the radar screen display application 3b is complete (YES at step S105), the CPU 12B executes any other application or terminates the operation.

On the other hand, if the execution processing of the radar screen display application 3b is not complete (NO at step S105), the CPU 12B checks the progress, of the execution code 3b-1 of the radar screen display application 3b in accordance with a progress management code 3b-2 and determines whether or not the execution processing will be complete within the CPU time 50 msec allocated to the radar screen display application 3b (step S106).

If the CPU 12B determines that the execution processing of the radar screen display application 3b will be complete within the allocated CPU time 50 msec (YES at step S106), the CPU 12B continues the execution processing of the execution code 3b-1 (step S104).

On the other hand, if the CPU 12B does not determine that the execution processing of the radar screen display application 3b will be complete within the allocated CPU time 50 msec (NO at step S106), the CPU 12B requests the CPU 12A to reallocate the CPU time in accordance with the progress management code 3b-2.

Upon reception of the request for reallocating the CPU time from the CPU 12B executing the radar screen display application 3b, the CPU 12A reallocates the CPU time to the radar screen display application 3b within the upper limit of unallocated CPU time 200 msec stored as the current period storage array 2-2 (FIG. 5) in accordance with the allocation code 2-1 of the scheduler 2 (YES at step S107 and S108).

If shortage of the CPU time allocated to the execution processing of the radar screen display application 3b is eliminated as the CPU time is reallocated (YES at step S109), the CPU 12A notifies the CPU 12B that the CPU time has been reallocated. The CPU 12B further executes the execution code 3b-1 and the progress management code 3b-2 in accordance with the radar screen display application 3b to which the CPU time is reallocated (step S104, S106).

On the other hand, even if the request for reallocating the CPU time is received from the CPU 12B executing the radar screen display application 3b, if unallocated CPU time stored as the current period storage array 2-2 is not available (NO at step S107) or if shortage of the CPU time allocated to the execution processing of the radar screen display application 3b is not eliminated although the CPU time is reallocated (NO at step S109), the CPU 12A reallocates the CPU time to the radar screen display application 3b within the upper limit of unallocated CPU time 150 msec stored as the next period storage array 2-3 (FIG. 6) in accordance with the allocation code 2-1 of the scheduler 2 (YES at step S110 and S111). The CPU 12A notifies the CPU 12B that the CPU time has been reallocated. The CPU 12B further executes the execution code 3b-1 and the progress management code 3b-2 in accordance with the radar screen display application 3b to which the CPU time is reallocated (step S104, S106).

On the other hand, if unallocated CPU time stored as the next period storage array 2-3 is not available (NO at step S110), the CPU 12B aborts the execution processing of the radar screen display application 3b (step S112).

The CPU 12B may abort the execution processing of the radar screen display application 3b in accordance with the radar screen display application 3b or in accordance with the OS 1. If the radar screen display application 3b is created by a third party or if the radar screen display application 3b contains a defect, the CPU 12B forcibly aborts the execution processing of the radar screen display application 3b in accordance with the OS 1.

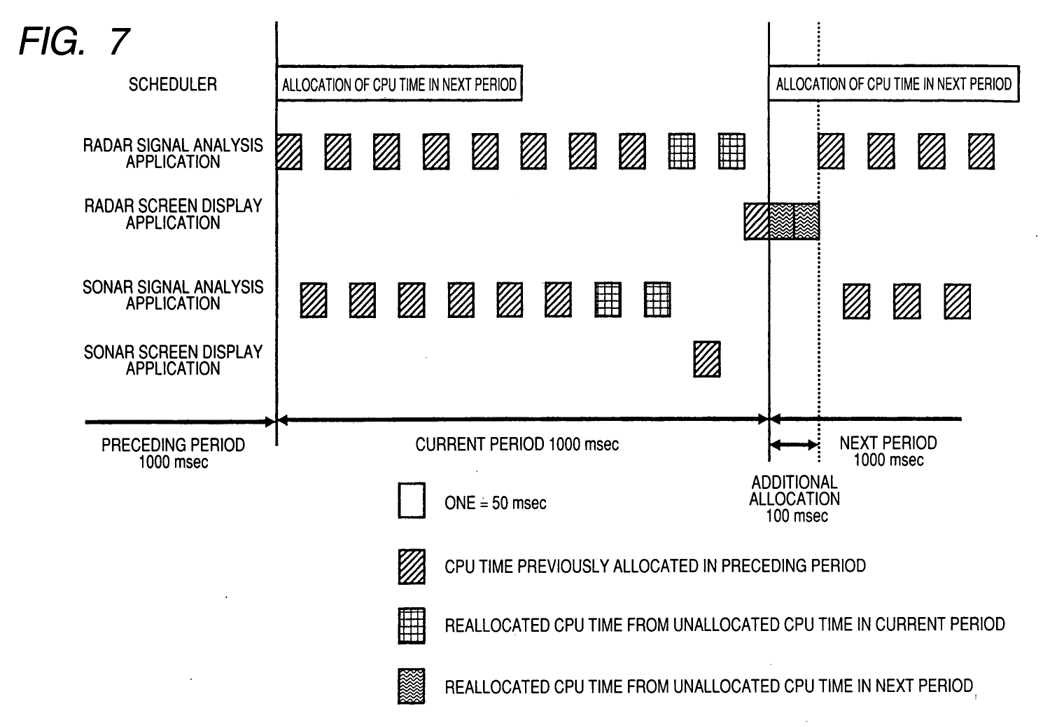

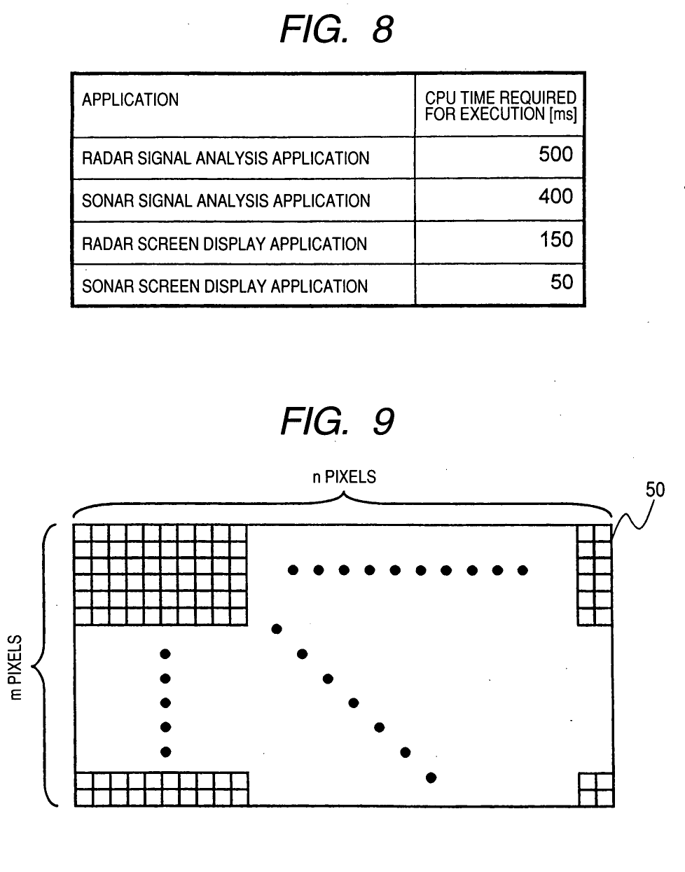

FIG. 7 is a drawing to show an example of processing when the CPUs 12A and 12B execute the scheduler 2 and the applications 3. It is assumed that the CPU time allocation result to the applications 3 in the current period is as shown in FIG. 5. It is assumed that the CPU time allocation result to the applications 3 in the next period is as shown in FIG. 6. It is assumed that the CPU time required for execution processing of the applications 3 at the time of actual execution of the applications 3 in the current period is as shown in FIG. 8.

To begin with when the preceding period is switched to the current period, the CPU 12A starts execution of the scheduler 2 and the CPU 12B starts execution of the radar signal analysis application 3a and the sonar signal analysis application 3c.

The CPU 12B executes the radar signal analysis application 3a and the sonar signal analysis application 3c alternately for each time slice (50 msec) in accordance with the CPU time allocated beforehand in the preceding period (FIG. 5).

Since execution processing of the radar signal analysis application 3a and the sonar signal analysis application 3c is not complete within the CPU time allocated beforehand in the preceding period and unallocated CPU time in the current period is available, the CPU time is reallocated from the unallocated CPU time in the current period. The CPU 12B performs execution processing of the radar signal analysis application 3a and the sonar signal analysis application 3c spending the CPU time allocated beforehand in the preceding period and the reallocated CPU time.

After completion of the execution processing of the radar signal analysis application 3a and the sonar signal analysis application 3c, the CPU 12B starts execution processing of the radar screen display application 3b and the sonar screen display application 3d.

The CPU 12B has completed the execution processing of the sonar screen display application 3d within the CPU time allocated beforehand in the preceding period. On the other hand, the CPU 12B has not completed the execution processing of the radar screen display application 3b within the CPU time allocated beforehand in the preceding period. Since unallocated CPU time in the current period is not available and unallocated CPU time in the next period is available, the CPU 12A reallocates the CPU time from the unallocated CPU time in the next period in accordance with the scheduler 2. The CPU 12B performs execution processing of the radar screen display application 3b spending the CPU time allocated beforehand in the preceding period and the reallocated CPU time.

FIG. 9 is a drawing to show pixels of a screen of the display 50.

The display 50 has m×n pixels in total as a matrix with m rows (m is an integer greater than or equal to one) and n columns (n is an integer greater than or equal to one). The CPU 12B calculates the intensity of each pixel from the analysis result provided by executing the radar signal analysis application 3a in accordance with the radar screen display application 3b. The CPU 12B may calculate the color of each pixel (R (red), G (green), B (blue)) in accordance with the radar screen display application 3b.

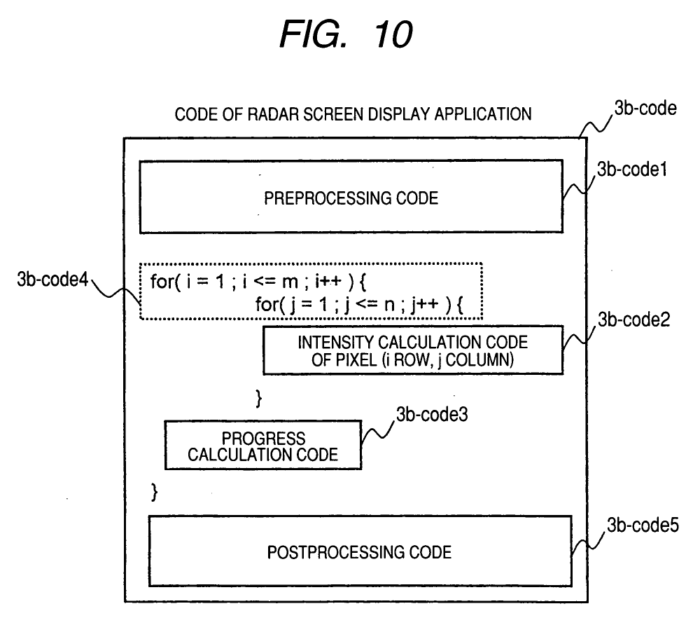

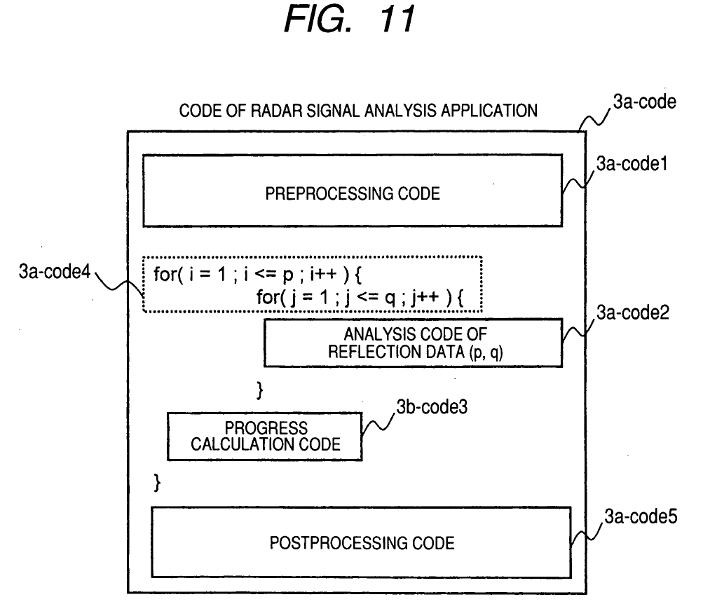

FIG. 10 is a drawing to show an example of codes 3b-code of the radar screen display application 3b. It is to be understood that codes of the sonar screen display application 3d are also implemented as codes similar to those in FIG. 10 except that the analysis result provided by executing the sonar signal analysis application 3c rather than the analysis result provided by executing the radar signal analysis application 3a is used.

The radar screen display application 3b has a preprocessing code 3b-code1, a pixel intensity calculation code 3b-code2, a progress calculation code 3b-code3, a loop code 3b-code4, and a postprocessing code 3b-code5.

The preprocessing code 3b-code1 is a code for reading the analysis result stored in the main memory 11, etc.

The pixel intensity calculation code 3b-code2 is a code for calculating the intensity of pixel row i, column j from the analysis result provided by executing the radar signal analysis application 3a. “i” and “j” are loop counter values; “i” is swept from “1” to “m” and “j” is swept from “1” to “n.”

The progress calculation code 3b-code 3 is a code for calculating the progress of the radar screen display application 3b at the point in time of executing the progress calculation code 3b-code3 according to an expression of [{(i/m)*100}%]. For example, when the display 50 displays screen information in 1600×1200 pixels, “m” becomes 1200 rows and if the loop counter value “i” is 600, the progress degree is calculated as {(600/1200)*100}%= 50%. The progress calculation code 3b-code3 may be a code for calculating the progress of the radar screen display application 3b according to an expression considering the preprocessing code 3b-code1, the postprocessing code 3b-code5, etc.

The progress calculation code 3b-code3 is executed each time loop processing is repeated “n” times in the example shown in FIG. 10, but may be a code executed each time one loop processing is executed. The progress calculation code 3b-code3 may be a code executed when a timer reaches a predetermined time regardless of the number of times of loop processing. For example, the progress calculation code 3b-code3 may be executed at the time of a lapse of 90% of period 1000 msec, namely, 900 msec since switching to the current period.

The loop code 3b-code4 is “for statement” shown in FIG. 10, for example, and is a code for executing the pixel intensity calculation code 3b-code2 and the progress calculation code 3b-code3 repeatedly at regular time intervals.

The postprocessing code 3b-code5 is a code for forming screen information to be transmitted to the display 50 from the intensity of each pixel.

FIG. 11 is a drawing to show an example of codes 3a-code of the radar signal analysis application 3a. It is to be understood that codes of the sonar signal analysis application 3c are also implemented as codes similar to those in FIG. 11 except that the sensing result of the sonar set 30 rather than the sensing result of the radar set 20 is used.

The radar signal analysis application 3a has a preprocessing code 3a-code1, a reflection data analysis code 3a-code2, a progress calculation code 3a-code3, a loop code 3a-code4, and a postprocessing code 3a-code5.

The preprocessing code 3a-code1 is a code for reading the sensing result stored in the main memory 11, etc.

The reflection data analysis code 3a-code2 is a code for analyzing the sensing result of the radar set 20, namely, data indicating information of a reflected wave when a radio wave is transmitted with respect to elevation angle “i” and azimuth angle “j.” “i” and “j” are loop counter values; “i” is swept from “1” to “p” and “j” is swept from “1” to “q.”

The progress calculation code 3a-code3 is a code for calculating the progress of the radar screen display application 3b at the point in time of executing the progress calculation code 3a-code3 according to an expression of [{(i/p)*100}%]. The progress calculation code 3a-code3 may be a code for calculating the progress of the radar signal analysis application 3a according to an expression considering the preprocessing code 3a-code1, the postprocessing code 3a-code5, etc.

The loop code 3a-code4 is “for statement” shown in FIG. 11, for example, and is a code for executing the reflection data analysis code 3a-code2 and the progress calculation code 3a-code3 repeatedly at regular time intervals.

The postprocessing code 3a-code5 is a code for putting the analysis results of the reflection data together and forming the analysis result of the sensing result from the radar set 20.

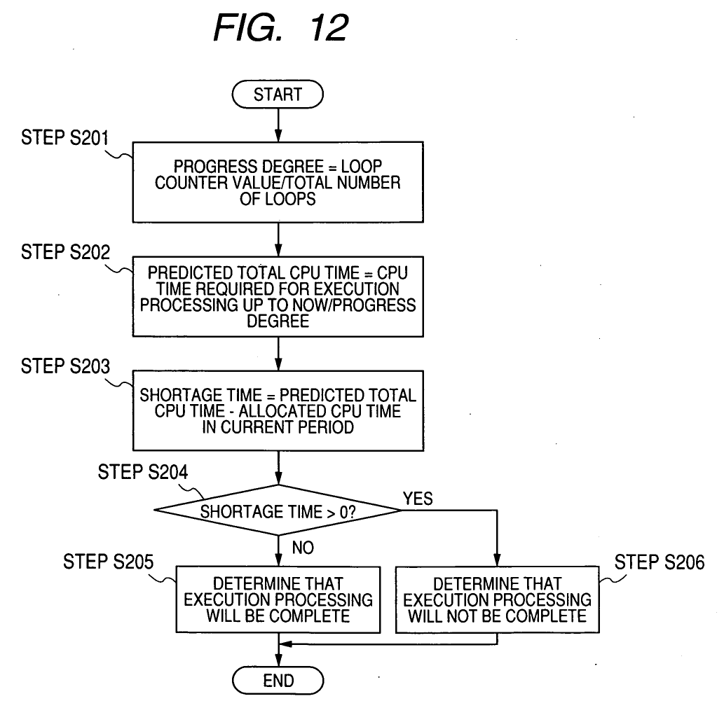

FIG. 12 is a flow chart to show the operation for the CPU 12B to determine whether or not execution processing of the application being executed will be complete within the CPU time allocated in the current period in accordance with the progress management code 3b-2 of each application at step S106 in FIG. 4. The progress management code 3b-2 has the progress calculation code 3b-code3.

To begin with, the CUP 12B sets the result of dividing the loop counter value by the total number of loop times as the progress degree (step S201).

Next, the CPU 12B sets the result of dividing the CPU time required for the application execution processing up to now by the progress degree as the CPU time predicted to be required for the execution processing of the application being executed (which will be hereinafter called predicted total CPU time) (step S202). It is assumed that the CPU 12B manages the CPU time required for the application execution processing up to now in accordance with the OS 1.

Next, the CPU 12B sets the result of subtracting the CPU time allocated in the current period (which will be hereinafter called allocated CPU time in the current period) from the predicted total CPU time as the CPU time insufficient to perform application execution processing (which will be hereinafter called shortage time) (step S203).

If the shortage time is 0 or less (NO at step S204), the CPU 12B determines that the execution processing of the application being executed will be complete within the allocated CPU time in the current period (step S205).

On the other hand, if the shortage time is greater than 0 (YES at step S204), the CPU 12B determines that the execution processing of the application being executed will not be complete within the allocated CPU time in the current period (step S206).

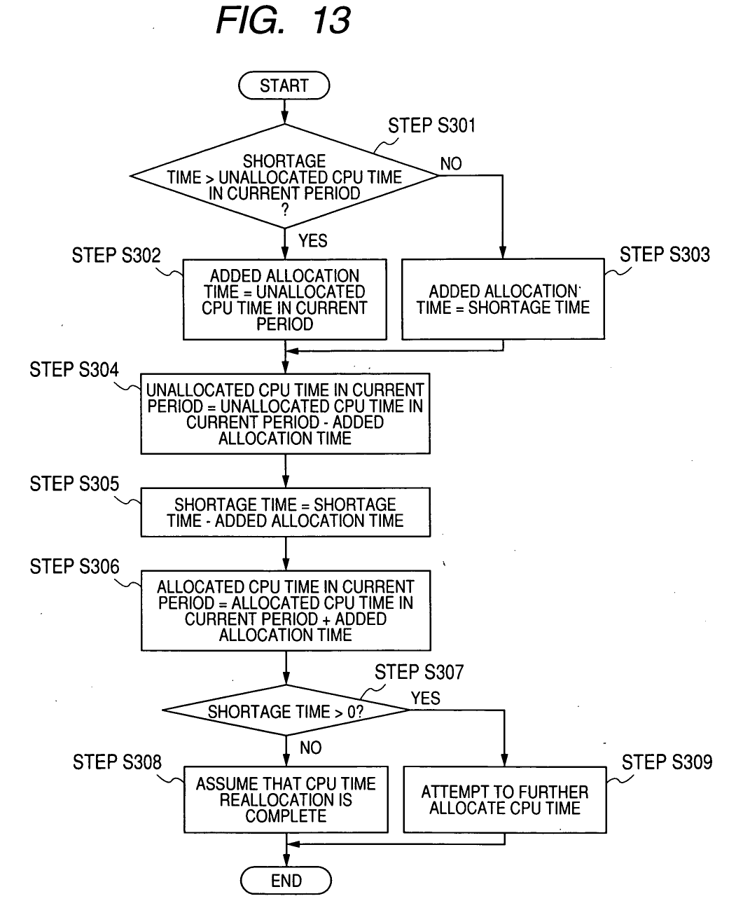

FIG. 13 is a flowchart to show the operation for the CPU 12A to reallocate the CPU time to the application from unallocated CPU time in the current period in accordance with the allocation code 2-1 of the scheduler 2 at steps S107 to S109 in FIG. 4.

To begin with, the CPU 12A receives the application type and the shortage time for execution of the application as a CPU time reallocation request from the CPU 12B.

Next, the CPU 12A determines whether or not the shortage time is greater than the unallocated CPU time in the current period (step 301). The shortage time is calculated by the CPU 12B in accordance with the progress management code 3b-2 at step S203 in FIG. 12.

If the CPU 12A determines that the shortage time is greater than the unallocated CPU time in the current period (YES at step S301), the CPU 12A determines that the CPU time to be added when the CPU time is reallocated to the application (which will be hereinafter called added allocation time) is all the remaining time of the unallocated CPU time in the current period (step S302).

On the other hand, if the CPU 12A does not determine that the shortage time is greater than the unallocated CPU time in the current period (NO at step S301), the CPU 12A sets the added allocation time to the shortage time (step S303).

Next, the CPU 12A updates the unallocated CPU time in the current period to the result of subtracting the added allocation time from the unallocated CPU time in the current period (step S304).

Next, the CPU 12A updates the shortage time to the result of subtracting the added allocation time from the shortage time (step S305).

Next, the CPU 12A updates the allocated CPU time in the current period to the result of adding the allocated CPU time in the current period and the added allocation time as for the application to which the CPU time is reallocated (step S306).

Next, the CPU 12A determines whether or not the shortage time is greater than 0 (step S307).

If the CPU 12A does not determine that the shortage time is greater than 0 (NO at step S307), the CPU 12B assumes that reallocation of the CPU time to the application is complete, (step S308), and makes a transition to any other processing, for example, application execution processing, etc.

On the other hand, if the CPU 12A determines that the shortage time is greater than 0 (YES at step S307), the CPU 12A assumes that the CPU time reallocated to the application is insufficient (step S309), and attempts to further allocate the CPU time.

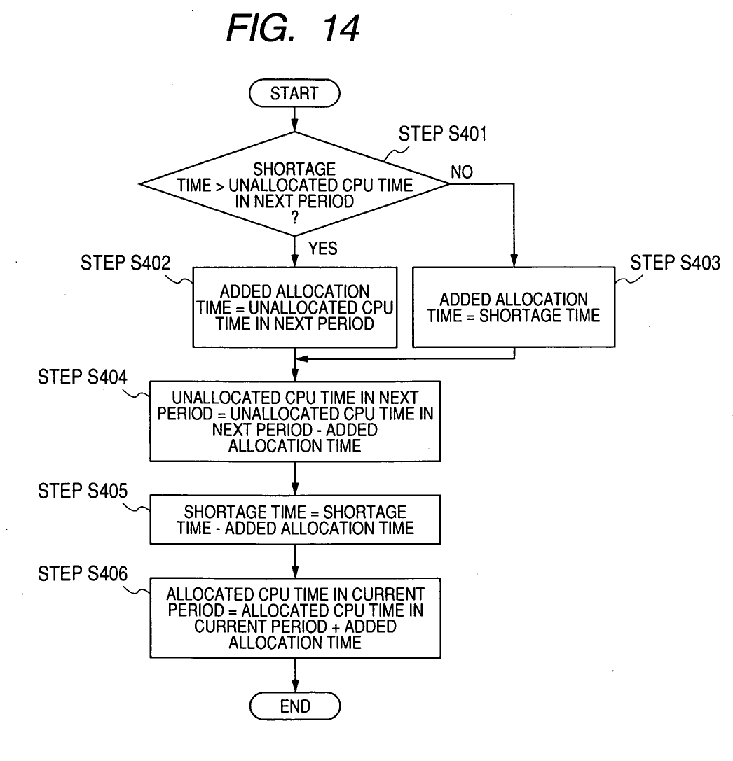

FIG. 14 is a flowchart to show the operation for the CPU 12A to reallocate the CPU time to the application from unallocated CPU time in the next period in accordance with the allocation code 2-1 of the scheduler 2 at steps S110 and S111 in FIG. 4.

To begin with, the CPU 12A determines whether or not the shortage time is greater than the unallocated CPU time in the next period (step S401). The shortage time is calculated by the CPU 12A at step S203 in FIG. 12 or step S305 in FIG. 13.

If the CPU 12A determines that the shortage time is greater than the unallocated CPU time in the next period (YES at step S401), the CPU 12A determines that the added allocation time is all the remaining time of the unallocated CPU time in the next period (step S402).

On the other hand, if the CPU 12A does not determine that the shortage time is greater than the unallocated CPU time in the next period (NO at step S401), the CPU 12A sets the added allocation time to the shortage time (step S403).

Next, the CPU 12A updates the unallocated CPU time in the next period to the result of subtracting the added allocation time from the unallocated CPU time in the next period (step S404).

Next, the CPU 12A updates the shortage time to the result of subtracting the added allocation time from the shortage time (step S405).

Next, the CPU 12A updates the allocated CPU time in the current period to the result of adding the allocated CPU time in the current period and the added allocation time as for the application to which the CPU time is reallocated (step S406).

Thus, according to the sensor information system 100 according to the first embodiment, when application execution processing occurring every period is performed, the CPU time is allocated beforehand to each application 3 to be executed in the next period, whereby if an application whose execution processing is not complete during the current period exists, an additional CPU time is reallocated to the application whose execution processing is not complete within the upper limit of the CPU idle time in the next period, so that aborting of application execution processing is suppressed.

The scheduling function of the sensor information system 100 is implemented by letting the CPUs installed in the information processing apparatus 10 execute programs; however, the scheduling function can be implemented using dedicated hardware.

For example, the information processing apparatus 10 may include a current period storage section and a next period storage section of memories for storing the current period storage array 2-2 and the next period storage array 2-3 and may include a progress management section having a function implemented as the CPU 12B executes the progress management code of each application and a CPU time allocation section having a function implemented as the CPU 12A executes the allocation code 2-1 of the scheduler 2 as dedicated hardware in place of the CPUs 12A and 12B for performing execution processing of each application 3.

### SECOND EMBODIMENT

The codes of the applications of the sensor information system 100 according to the first embodiment have the loop code and, for example, the result of dividing the loop counter value by the total number of loop times is adopted as the progress of the application. On the other hand, codes of applications of a sensor information system according to a second embodiment of the invention have codes indicating the progress degree. The sensor information system according to the second embodiment and the sensor information system 100 according to the first embodiment differ in application codes and therefore other points will not be discussed again.

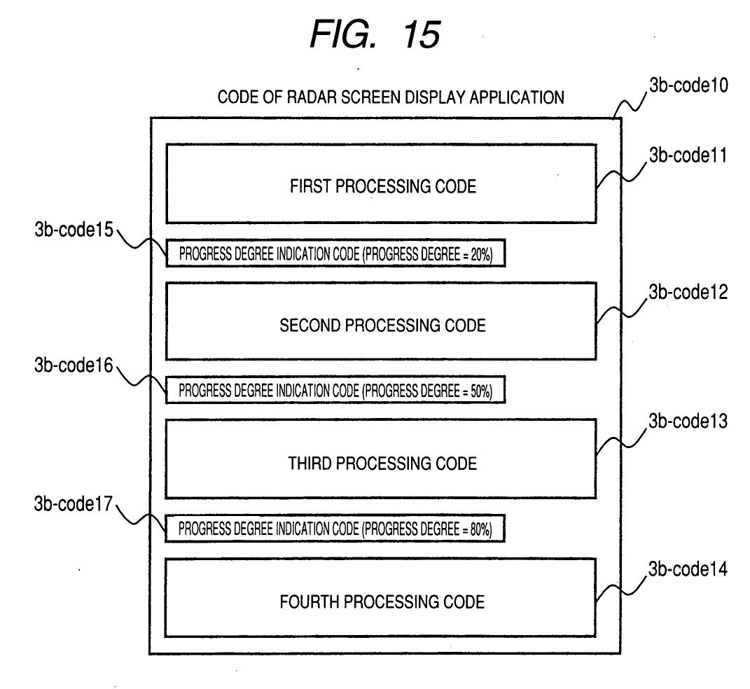

FIG. 15 is a drawing to show an example of the configuration of codes 3b-code10 of a radar screen display application 3b. It is to be understood that each of a radar signal analysis application 3a, a sonar signal analysis application 3c, and a sonar screen display application 3d is also implemented as codes similar to those in FIG. 15.

The codes 3b-code10 of the radar screen display application 3b have first to fourth processing codes 3b-code11 to 3b-code14 and progress degree indication codes 3b-code15 to 3b-code17.

The first to fourth processing codes 3b-code11 to 3b-code14 are codes provided by dividing the codes 3b-code10 of the radar screen display application 3b into four in response to the function type, phase, etc.

The progress degree indication code 3b-code15 is inserted between the first processing code 3b-code11 and the second processing code 3b-code12, the code 3b-code16 is inserted between the second processing code 3b-code12 and the third processing code 3b-code13, and the code 3b-code17 is inserted between the third processing 3b-code13 and the fourth processing code 3b-code14.

The progress degree indication code 3b-code15 inserted between the first processing code 3b-code11 and the second processing code 3b-code12 indicates that the progress degree is 20%. That is, the CPU time required for execution processing of the first processing code 3b-code11 is 20% of the CPU time required for executing the first to fourth processing codes 3b-code11 to 3b-code14.

The progress degree indication code 3b-code16 inserted between the second processing code 3b-code12 and the third processing code 3b-code13 indicates that the progress degree is 50%. That is, the CPU time required for execution processing of the first and second processing codes 3b-code11 and 3b-code12 is 50% of the CPU time required for executing the first to fourth processing codes 3b-code11 to 3b-code14.

The progress degree indication code 3b-code17 inserted between the third processing code 3b-code13 and the fourth processing code 3b-code14 indicates that the progress degree is 80%. That is, the CPU time required for execution processing of the first to third processing codes 3b-code11 to 3b-code13 is 80% of the CPU time required for executing the first to fourth processing codes 3b-code11 to 3b-code14.

When a CPU 12B determines whether or not execution processing of each application 3 will be complete within the allocated CPU time in the current period in accordance with the progress degree indication code of the application 3, the CPU 12B reads the progress degree indicated by the progress degree indication code rather than executes progress degree calculation processing (step S201 in FIG. 12). The CPU 12B makes a CPU time reallocation request based on the read progress degree. The number of divisions of the codes of each application 3 in response to the function type, phase, etc., is not limited to four.

Thus, a code for specifying the progress degree of each application is inserted into the code of the application, whereby the progress is kept track of in the application not looped as a whole. The code for specifying the progress degree of each application is not limited to the mode described above and can be provided in any of various modes.

It is to be understood that the invention is not limited to the specific embodiments described above and that the invention can be embodied with the components modified without departing from the spirit and scope of the invention. The invention can be embodied in various forms according to appropriate combinations of the components disclosed in the embodiments described above.

As described with reference to the embodiment, there is provided an information processing apparatus, a control method of the information processing apparatus, and a control program of the information processing apparatus for making it possible to suppress aborting of execution processing of an application occurring every period.

What is claimed is:

1. A computer readable storage medium that stores a software program causing a computer system to perform a scheduling process for executing a plurality of application programs in every processor cycles, the scheduling process comprising:
allocating, during a current processor cycle, processor times of a next processor cycle to each of the application programs to be executed in the next processor cycle;
storing the allocated processor times of the next processor cycle;
determining whether or not the application programs executed in the current processor cycle include an uncompletable application program that will not be completed within the current processor cycle;
calculating processor idle time of the next processor cycle from a difference between a sum of the stored processor times of the next processor cycle and a length of the processor cycle, when determined that the uncompletable application program is included in the application programs, executed in the current processor cycle; and
allocating an additional processor time of the next processor cycle to the uncompletable application program, the additional processor time being set not to exceed the calculated processor idle time of the next processor cycle.

2. The computer readable storage medium according to claim 1, wherein the scheduling process further comprising:
allocating, during previous processor cycle, processor times of the current processor cycle to each of the application programs to be_executed in the current processor cycle;
storing the allocated processor times of the current processor cycle;
calculating processor idle time of the current processor cycle from a difference between a sum of the stored processor times of the current processor cycle and a length of the processor cycle, when determined that the uncompletable application program is included in the application programs executed in the current processor cycle; and
allocating an additional processor time of the current processor cycle to the uncompletable application program, the additional processor time being set not to exceed the calculated processor idle time of the current processor cycle.

3. The computer readable storage medium according to claim 2, wherein the processor idle time of the next processor cycle is allocated to the uncompletable application program when the processor idle time in the current processor cycle is not available.

4. The computer readable storage medium according to claim 1, wherein, when the determining step, processor time spent for the application programs executed in the current processor cycle and degree of progress of the application programs executed in the current processor cycle are referred for the determination.

5. The computer readable storage medium according to claim 1, wherein at least one of the application programs executed in the current processor cycle lets the computer system perform the determining step.

6. The computer readable storage medium according to claim 5, wherein at least one of the application programs includes a loop code for performing a repeat process, and
wherein, in the determining step, processor time spent for the application programs executed in the current processor cycle and number of executions of the repeat process in the current processor cycle are referred for the determination.

7. The computer readable storage medium according to claim 6, wherein at least one of the application programs is configured to indicate degree of progress of the one of the application programs, and
wherein, in the determining step, the indicated degree of progress is referred for the determination.

8. A control method of an information processing apparatus to perform a scheduling process for executing tasks for a plurality of application programs in every processor cycles, the control method comprising:
allocating, during a current processor cycle, processor times of a next processor cycle to each of the application programs to be executed in the next processor cycle;
storing the allocated processor times of the next processor cycle;
determining whether or not the application programs executed in the current processor cycle include an uncompletable application program that will not be completed within the current processor cycle;
calculating processor idle time of the next processor cycle from a difference between a sum of the stored processor times of the next processor cycle and a length of the processor cycle, when determined that the uncompletable application program is included in the application programs executed in the current processor cycle; and
allocating an additional processor time of the next processor cycle to the uncompletable application program, the additional processor time being set not to exceed the calculated processor idle time of the next processor cycle.

9. An information processing apparatus comprising:
a processor that executes a plurality of application
programs in every processor cycles; and
a memory that stores processor times,
wherein the processor operates:
allocating, during a current processor cycle, processor times of a next processor cycle to each of the application programs to be executed in the next processor cycle;
storing the allocated processor times of the next processor cycle to the memory;
determining whether or not the application programs executed in the current processor cycle include an uncompletable application program that will not be completed within the current processor cycle;
calculating processor idle time of the next processor cycle from a difference between a sum of the stored processor times of the next processor cycle and a length of the processor cycle, when determined that the uncompletable application program is included in the application programs executed in the current processor cycle; and
allocating an additional processor time of the next processor cycle to the uncompletable application program, the additional processor time being set not to exceed the calculated processor idle time of the next processor cycle.

10. An information processing apparatus comprising:
a processor that executes a plurality of application programs in every processor cycles;
a first allocation unit that allocates processor times of next processor cycle to each task of next application programs to be executed in the next processor cycle during the current processor cycle;
a storing unit that stores the allocated processor times of the next processor cycle;
a determination unit that determines whether or not the application programs executed in the current processor cycle include an uncompletable application program that will not be complete within the current processor cycle;
a calculation unit that calculates processor idle time of the next processor cycle from a difference between a sum of the stored processor times of the next processor cycle and a length of the processor cycle, when determined that the uncompletable application program is included in the application programs executed in the current processor cycle; and
a second allocation unit that allocates an additional processor time of the next processor cycle to the uncompletable application program, the additional processor time being set not to exceed the calculated processor idle time of the next processor cycle.
